(19) United States
(12) Patent Application Publication
(10) Pub. No.: US 2006/0173696 A1
(43) Pub. Date: Aug. 3, 2006

(54) Method and apparatus for product management

(76) Inventors: Julie Ward Drew, Redwood City, CA (US); Qi Feng, Richardson, TX (US); Bin Zhang, Freemont, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/047,227

(22) Filed: Jan. 31, 2005

(51) Int. Cl. G06Q 99/00

(52) U.S. Cl. 705/1

(57) ABSTRACT

A method for selecting products includes solving a maximal s-t flow in a bipartite graph to obtain a minimum cut for the bipartite graph and selecting products bounded by the minimum cut. An apparatus for product selection is also described.

### BACKGROUND

Product proliferation is a concern for many business enterprises because making or selling numerous products adds to inventory and management costs. Further, a business enterprise may lose sales as a result of consumer confusion stemming from numerous product choices. In today's fast paced business climate, businesses attempt to monitor the financial success of the products that are offered for sale. Businesses strive to select a particular product portfolio for sale to customers that increase the business' profit.

### BRIEF DESCRIPTION OF THE DRAWINGS

For a detailed description of exemplary embodiments of the invention, reference will now be made to the accompanying drawings in which:

FIG. 1 shows a s-t flow graph with minimal s-t cut in accordance with an embodiment of the invention;

FIG. 2 shows a flowchart highlighting a method for product portfolio selection in accordance with an embodiment of the invention; and

FIG. 3 shows a computer system in accordance with an embodiment of the invention.

### NOTATION AND NOMENCLATURE

Certain term(s) are used throughout the following description and claims to refer to particular system components. As one skilled in the art will appreciate, different companies/industries may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In accordance with various embodiment of the invention, methods and apparatuses are described that reduce the number of products included in a product portfolio to a set of products that is expected to cover most, or at least a substantial amount of order revenue. The disclosed approach helps reduce the costs associated with managing a product offering without substantially sacrificing the variety that customers may desire and the associated revenue from customer demand.

As an illustrative example, in the personal computer (PC) business, a customer's order can comprise a particular set of products such as a chassis, processor, memory card, graphics card, monitor, mouse, keyboard and power cable. An order is said to be “covered” by a product set if every product in the order is included in the set. A method is described for selecting a set of at most n products to offer for sale to maximize the revenue of orders that are covered by the product set for a range of product sets of different sizes. The method generates a plurality of product portfolios along an efficient frontier of revenue coverage and set size. In one embodiment, the efficient frontier is the plot line showing where revenue is maximized versus portfolio size.

To better describe embodiments of the invention, some mathematical notation is first presented. Because it is desirable to find a set of products of a size of at most “n” that maximizes the revenue of orders covered, as a first step, the problem can be formulated as an integer program model (denoted by IP(n)) by defining decision variables, constraints and an objective function as follows for IP(n):

Decision Variables

Let Xₚ=1 if product “p” is included in the product portfolio, otherwise Xₚ=0.
Let Yₒ=1 if order “o” is covered by the portfolio, otherwise Yₒ=0.
   Constraints
Order o is covered if each product p in the order is included:
   Yₒ≦Xₚ for each product-order combination (o,p).
At most n products are included: ΣₚXₚ≦n.
X and Y variables are binary: Xₚ∈E{0,1}, Yₒ ∈{0,1}.
X and Y comprise vectors that represent products and orders respectively.
   Objective Function
   Maximize the total revenue of orders covered by the product portfolio: ΣₒRₒYₒ.

In accordance with an embodiment of the invention, the requirement that the Xₚ,Yₒ variables comprise binary values is relaxed, and is replaced with a requirement that permits Xₚ,Yₒ to be continuous variables with values in a particular range such as in the interval of 0 to 1. This latter requirement in which Xₚ,Yₒ comprise values in a particular range transforms the problem into a linear program which can be solved faster than the integer program model above. Secondly, the constraint that ΣₚXₚ≦n is eliminated and is replaced with a penalty term in the objective, −λΣₚXₚ. The number of products used in the solution is penalized by a nonnegative number λ, which will be referred to as the Langrangian Relaxation, LR(λ) or linear programming relaxation.

Some notation used for LR(λ) include:

Decision Variables

Xₚ
Yₒ
   Constraints
Order o is covered if each product p in the order is included:
   Y₀≦Xₚ for each product-order combination (o,p).
X and Y variables are between zero and 1:0≦Xₚ≦1 and 0≦Yₒ≦1.
   Objective Function

Maximize the total revenue of orders covered minus the penalty of using more than target product set size n: ΣₒRₒYₒ−λ(ΣₚXₚ−n), or equivalently, since −λn is a constant, maximize the total revenue of orders covered minus λ times the number of products included in the product portfolio: ΣₒRₒYₒ−λΣₚXₚ.

Changing the objective function and constraints as shown above offers several advantages over the integer program. By eliminating the constraint ΣₚXₚ≦n and replacing it with a penalty in the objective function, the remaining set of constraints are completely unimodular. By using unimodular constraints, an integer solution will be obtained. Moreover, if a set of the orders and products (O, P) is the optimal solution to LR (λ), then the optimal solution will be an optimal solution to IP(|P|). One property of the series of solutions generated by the above technique is that the solutions are nested which means that for λ₁≦λ₂, the optimal product portfolio for LR(λ₂) is a subset of the optimal product portfolio for LR (λ₁).

By solving LR(λ) for a series of values of λ, a series of solutions to IP (n) for one or more values of “n” can be obtained. This series of solutions is along an efficient line of revenue coverage versus portfolio size. If the series of λ are chosen carefully, a dense curve of solutions can be found.

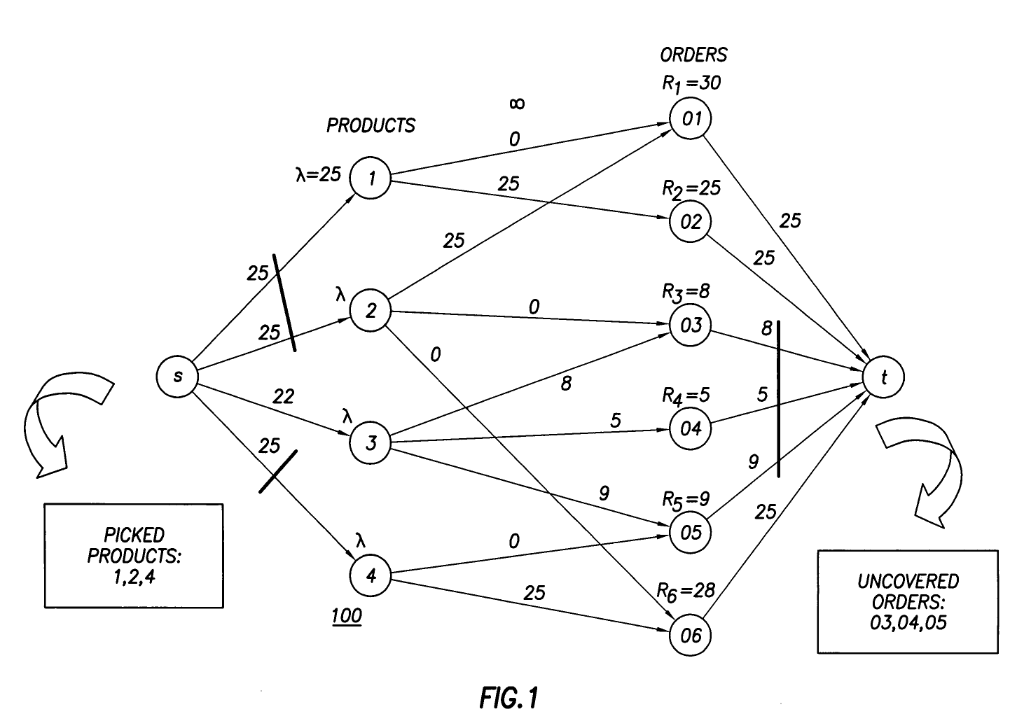

Although LR(λ) can be solved using a linear programming solver, solving for very large problems can take up to several hours. In accordance with an embodiment of the invention, the LR(λ) is recast as a maximum-flow problem. In FIG. 1, a graph 100 highlighting an illustrative maximum-flow problem is shown. The graph 100 includes a node corresponding to each of the products (labeled 1-4), 4), a node corresponding to each of the orders (labeled 26-30), a source node “s” and a sink node “t.” Links interconnect node “s” to each of the product nodes 1-4 with capacity equal to the penalty λ. For every product-order combination, an infinite capacity link exists between the corresponding product and order node. Also, a link exists from each order node O1-O6 to node “t”; and such links have a capacity equal to the order revenue.

By solving a maximal s-t flow problem in graph 100, a solution to LR(λ) can be obtained. A well-known result of graph theory is that the value of a maximal s-t flow is equal to the value of a minimum s-t cut, and that by solving a maximum s-t flow problem, a minimum s-t cut can be obtained. The s-t maximum flow problem aims to a flow of maximum value. A minimal s-t cut comprises the set of arcs of minimum capacity whose removal disconnects s from t. An s-t cut divides the set of nodes into two sets of nodes, node S (which contains node s) and node T (which contains node t). The cut itself contains all arcs directed from nodes in S to nodes in T. In FIG. 1, a minimum cut in the graph 100 corresponds to the solution of LR(λ). All the nodes in S correspond to unselected products, or orders that are uncovered by the selected product portfolio. Based on the minimum cut of the illustrative example shown in FIG. 1, products 1, 2 and 4 have been picked for the portfolio and orders O3, O4 and O5 are uncovered orders.

A maximal flow problem can be solved faster than the linear program LR(λ). For example, a “preflow-push” algorithm has complexity O(|o|²m) where |o| is the number of orders, and m is the number of order-product combinations. Linear programming techniques apply algorithms with higher complexity. The preflow-push algorithm for solving maximal flow problems of embodiments of the present invention can solve for LR(λ) more quickly than, at least some or most linear programming solvers.

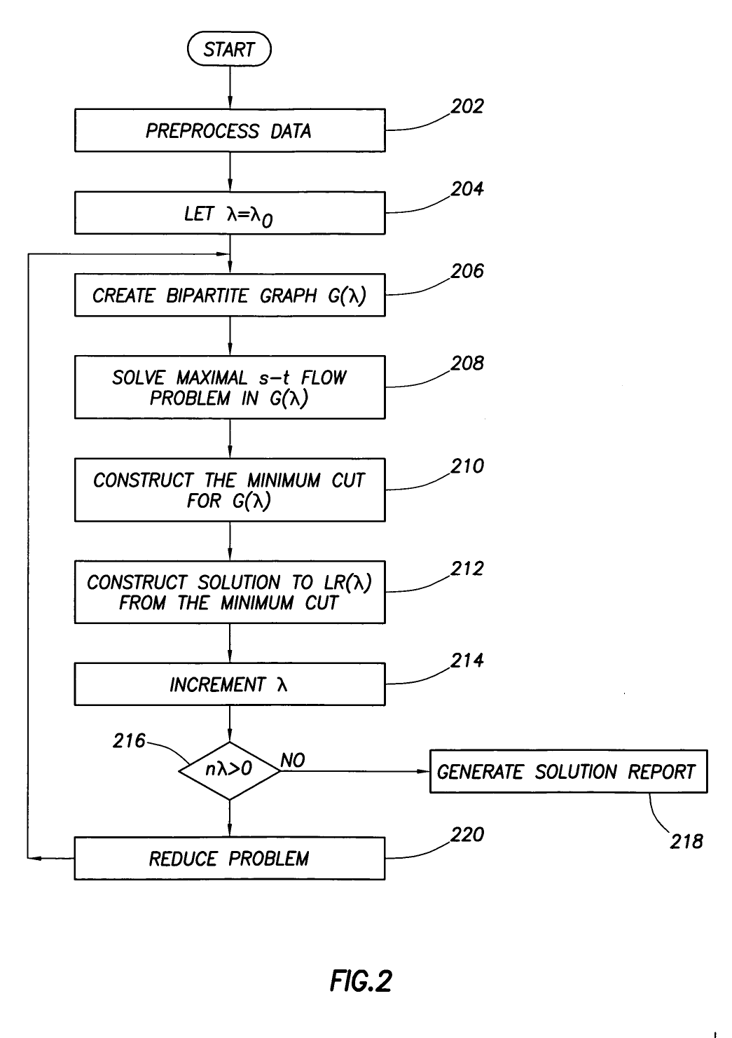

Referring now to FIG. 2, there is shown a flowchart exemplifying some of the actions taken in accordance with an embodiment of the invention. One or more of the actions shown in FIG. 2, can be performed in a different fashion from that shown. Further, the actions shown can be performed sequentially or two or more of the actions can be performed concurrently. The method shows how a series of maximum flow problems is solved to generate a series of solutions to LR(λ), for increasing values of λ. For consecutive values λ₁≦λ₂, the solution to LR(λ₁) can be used to speed up the computation of a solution to LR(λ₂) in two different ways. The first way is by using the maximum flow solution to LR(λ₁) as an initial solution to LR(λ₂). In the second way, the solution process is accelerated by eliminating some products and orders from the LR(λ₂) problem. Any unselected product in the LR(λ₁) solution will be unselected in the LR(λ₂) solution by the nested property of solutions. Similarly, any uncovered orders in the LR(λ₁) solution will be uncovered by the LR(λ₂) solution. Such products and orders can be eliminated, thereby reducing the problem size. One output of the method can be a chart of the efficient frontier of revenue coverage and portfolio size, and a nested series of portfolios corresponding to the points along that curve.

The method takes as an input, historical order data that includes each order and each product contained in each such order, as well as the order revenue data. Prior to commencing the routine the data is preprocessed in 202 in which data errors are removed and identical orders are consolidated. The data errors that are removed comprise errors such as orders having incorrect product numbers, etc. These orders are removed from consideration in order to avoid any data errors from occurring. Identical orders which include the same products in the order can be consolidated in order to simplify the computations.

In 204, λ is set equal to λₒ. In 206, a bipartite graph labeled as G(λ) is generated, which includes one node for each product, one node for each order, a source node, s, a sink node, t, a λ-capacity link from s to each product node, a Rₒ-apacity link from order “o” to the sink node t, and an infinite-capacity link from the product “p” node to the order “o” node for each p,o such that product p is in order o.

The maximal s-t flow problem for G(λ) is solved in 208. The solution to the problem is commenced with the previous flow solution, if available. When finished, the maximal flow is stored for use in subsequent flow problems for the next value of λ. The minimum cut for G(λ) is constructed in 210, which is obtained from the solution of the maximum flow. In 212, the solution for LR(λ) is constructed from the minimum cut. If the link from s to product p is included in the cut, then p is selected in the solution. If the link from order o to t is selected in the solution, then order o is uncovered by the portfolio of selected products.

In 214, λ is incremented by letting λ=λ+Δ, where Δ is a predetermined increment that can depend on particular system design requirements or other factors. In decision 216 it is determined if n(λ)>0, if it is 0 or less, the routine goes to 218 where a solution report is generated along an efficient frontier of revenue coverage and portfolio size. If in 218, it is determined that n(λ)>0 then the problem is reduced in 220. The problem is reduced in 220 by removing all unselected products from the previous solution. All orders that are uncovered are also removed and the routine then loops back to 206.

Embodiments of the invention can also be applied in a different way by, instead of starting with a small value of λ and increasing λ in each step as shown in FIG. 2, starting with a large value of λ and then decreasing λ in each process loop. For consecutive λ₁>λ₂, any product selected in the LR(λ₁) solution will be included in the LR(λ₂) solution by nestedness property. Similarly, any order covered in the LR(λ₁) solution will be included in the LR(λ₂) solution. Those products and orders can be deleted from the LR(λ₂) solution, although their identities are stored to reconstruct the solution. In further embodiments, the solutions from higher and lower values of λ can be saved, and the problem size from these solutions would be reduced in the ways discussed above.

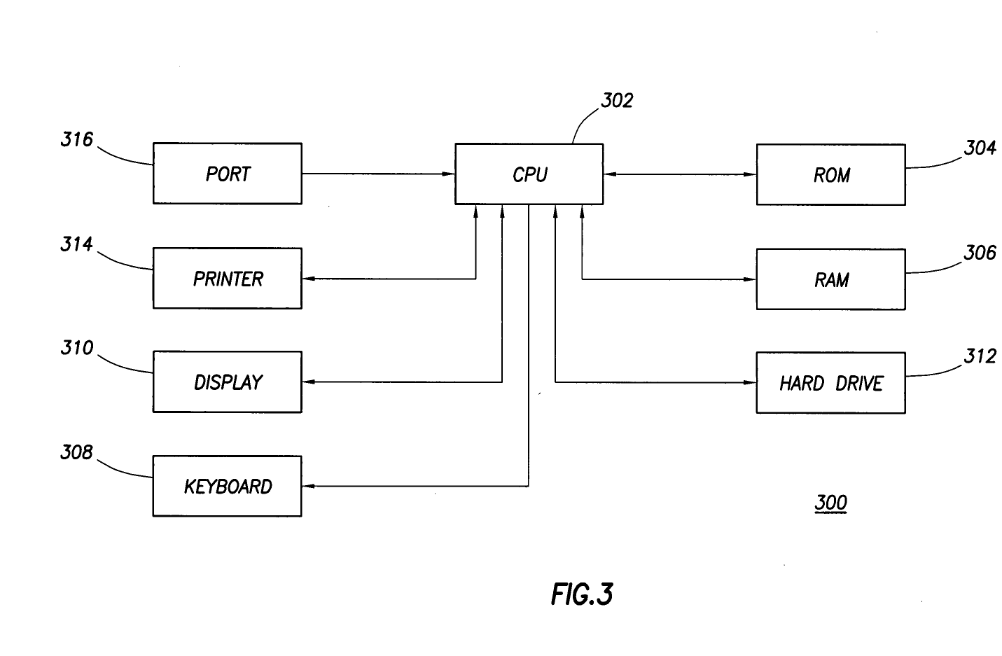

Referring now to FIG. 3, there is shown a computer system that can implement the method described above. The computer system 300 includes a central processing unit (CPU) 302, Read Only Memory (ROM) 304, Random Access Memory (RAM) 306, keyboard 308 for inputting information, display 310, non-volatile storage 312 (e.g., a hard drive), and a printer 314. The method described herein can be embodied in executable code stored on a storage medium such as the hard drive 312. The computer system 300 allows the revenue coverage optimization executable code to be executed on the CPU 302 with the results being stored on the hard drive 312 or other storage location. Historical product order data and order revenue data that are used in determining the products for the product portfolio can be received by input/output (I/O) port 316. I/O 316 can comprise an Ethernet, serial, parallel, or any other type of port. I/O port 316 receives the product order data and the order revenue data can be stored in servers or other data storage devices that are coupled via a network, such as a local area network (not shown) to computer system 300. In another embodiment where the hard drive 312 has stored therein the historical product order and order revenue data, then the CPU 302 can receive the data from the hard drive 312. The results can also be shown graphically on display 310 and/or printed using printer 314. The computer system 300 can be coupled to other computer systems via port 316. Results from computer system 300 can be sent to other systems (e.g., server, etc.) via the port 316 and results stored at a remote site or locally on hard drive 312.

While it has been described how to apply embodiments of the invention to achieve efficient revenue coverage versus product portfolio size, the results generalize to other objectives. Instead of maximizing order revenue, the same method can be applied to maximize order profit, number of orders, or any other metric/benefit associated with individual orders. The constraints can be based on portfolio size, portfolio cost, or any other metric associated with individual products. These generalizations affect the input data requirements. The invention is flexible enough to accommodate strategic constraints such as forced inclusion or exclusion of products by simply introducing a constraint into the integer and linear programs enforcing the inclusion/exclusion of the desired product.

The above discussion is meant to be illustrative of the principles and various embodiments of the present invention. Numerous variations and modifications will become apparent to those skilled in the art. It is intended that the following claims be interpreted to embrace all such variations and modifications.

What is claimed is:

1. A method for selecting products, comprising:
solving a maximal s-t flow in a bipartite graph to obtain a minimum cut for the bipartite graph; and
selecting products bounded by the minimum cut.

2. A method as defined in claim 1, wherein the products selected maximize a benefit.

3. A method as defined in claim 2, wherein the benefit comprises revenue maximization.

4. A method as defined in claim 1, wherein the bipartite graph is generated by:
establishing one node for every product, p, and one node for every order, o;
establishing a sink node (s);
establishing a source node (t);
establishing a λ-capacity link from node s to every product node, p;
establishing a Rₒ-capacity link from every order node o to node t; and
establishing an infinite capacity link from the product “p” node the order “o” node for each order and product such that product p is in order o.

5. A method as defined in claim 4, wherein, if a link from node s to a product node p is included in the minimum cut, then selecting product p.

6. A method as defined in claim 5, further comprising:
incrementing λ by a predetermined amount;
including only products previously selected after performing the minimum cut; and
repeating the generating, solving and constructing.

7. A method as defined in claim 1, wherein the minimum cut is constructed from a solution to the maximal s-t flow.

8. A method as defined in claim 1, wherein the selecting is subject to a limit on the number of products selected.

9. An apparatus, comprising:
a processor that receives order data for a plurality of historical orders, the order data comprising each product contained in the plurality of historical orders, the processor generates an integer model, and imposes a linear programming relaxation on decision variables associated with the products and orders, generates a bipartite graph corresponding to the linear programming relaxation, solves a maximal s-t flow in the bipartite graph and constructs a minimum cut for the bipartite graph in order to determine what products to include in a product portfolio.

10. The apparatus as defined in claim 9, wherein the processor selects a product portfolio that maximizes a benefit of orders covered by the product portfolio subject to a limit on the portfolio size or cost.

11. The apparatus as defined in claim 10 wherein the benefit comprises revenue.

12. An apparatus as defined in claim 10, wherein the apparatus comprises a computer.

13. An apparatus for selecting products, comprising:
means for receiving historical order information including product and order data; and
means for generating a bipartite graph for solving a maximal s-t flow in the bipartite graph and for constructing a minimum cut for the bipartite graph to determine what products are to be selected.

14. An apparatus as defined in claim 13, further comprising means for repeatedly generating the bipartite graph without including products removed by the minimum cut.

15. An apparatus as defined in claim 13, wherein the products that are selected maximize the revenue generated subject to a limit on the portfolio cost or size.

16. Application instructions on a computer-usable medium where the instructions, when executed, effect the selection of products, comprising:
solving a maximal s-t flow problem in a bipartite graph to obtain a minimum cut for the bipartite graph; and
selecting products bounded by the minimum cut.

17. A computer usable medium as defined in claim 16, wherein the products that are selected maximize revenue.

18. A computer usable medium as defined in claim 16, further comprising:
repeating the solving and selecting using a new bipartite graph that only includes previously selected products in order to obtain a new minimum cut for the new bipartite graph; and
selecting products using the new minimum cut in order to provide another solution.

19. A computer usable medium as defined in claim 18, wherein the solutions are used to generate a plot of revenue coverage and portfolio size.

20. A computer usable medium as defined in claim 16, wherein the bipartite graph includes a node for each product and a node for each order.

21. A method for selecting products, comprising:
receiving order data for a plurality of historical orders, the order data including each product contained in the plurality of historical orders;
generating an integer model;
imposing a linear programming relaxation on decision variables associated with the products and plurality of historical orders;
generating a bipartite graph corresponding to the linear programming relaxation;
solving a maximal s-t flow in the bipartite graph; and
constructing a minimum cut for the bipartite graph in order to determine what products to include in a product portfolio.

22. The method as defined in claim 21, further comprising:
selecting the product portfolio that maximizes a benefit of orders covered by the product portfolio subject to a limit on the product portfolio size or cost.

23. The method as defined in claim 22 wherein the benefit comprises revenue.

24. A method for selecting products for a product portfolio in order to maximize the revenue generated by the orders covered by the product portfolio, comprising:
generating a bipartite graph by:
establishing one node for every product, p, and one node for every order, o;
establishing a sink node (s);
establishing a source node (t);
establishing a λ-capacity link from node s to every product node, p;
establishing a Rₒ-capacity link from every order node o to node t; and
establishing an infinite capacity link from the product “p” node the order “o” node for each order and product such that product p is in order o;
solving a maximal s-t flow in the bipartite graph to obtain a minimum cut for the bipartite graph;
selecting products for the product portfolio by those bounded by the minimum cut;
incrementing λ by a predetermined amount;
including in the product portfolio only products previously selected after performing the minimum cut; and
repeating the generating, solving and constructing.
